(19) United States
(12) Patent Application Publication
(10) Pub. No.: US 2009/0157610 A1
(43) Pub. Date: Jun. 18, 2009

(54) METHOD, SYSTEM, AND COMPUTER PROGRAM PRODUCT FOR APPLYING A GRAPHICAL HIERARCHICAL CONTEXT IN A SEARCH QUERY

(76) Inventors: Lloyd W. Allen, JR., Cary, NC (US); Jana H. Jenkins, Raleigh, NC (US); Steven M. Miller, Cary, NC (US); Jennifer M. Raisig, Durham, NC (US)

Correspondence Address: DILLON & YUDELL LLP, 8911 N. CAPITAL OF TEXAS HWY., SUITE 2110, AUSTIN, TX, 78759, US

(21) Appl. No.: 11/955,573

(22) Filed: Dec. 13, 2007

(51) Int. Cl. G06F 7/06

(52) U.S. Cl. 707/3; 707/E17.014

(57) ABSTRACT

A method, system, and computer program product for applying a graphical hierarchical context in a search query. A Hierarchical Context Ordering (HCO) utility monitors receipt of a search string entry. Upon detection of the search string entry, HCO utility determines at least one search result that is associated with the detected search string entry. Responsive to receipt of a selected search result, HCO utility identifies existing hierarchical placement information associated with at least one of the selected search result and at least one duplicate result of the selected search result. At least one of the selected search result and the at least one duplicate result is outputted within a topical hierarchy containing the hierarchical placement information. According to another embodiment, prior to the outputting step, at least one non-relevant topic from the existing hierarchical placement information is removed.

### BACKGROUND OF THE INVENTION

The present disclosure relates to the field of computers, and specifically to search query tools. Still more specifically, the present disclosure relates to the application of graphical hierarchical context in a search query.

Online search queries for a particular topic can sometimes result in multiple, identical, or nearly identical search results. A display of duplicate search results, by itself, is not helpful to a user, since the searcher cannot judge whether one duplicate search result is more on point than another duplicate search result. Moreover, assuming that a single search result is yielded (i.e., no duplicate search results), a searcher may still find difficulty in determining whether a particular search string entry will yield information that is most relevant to the searcher. As a result, a considerable amount of time is currently expended in identifying the most relevant information to the searcher.

### BRIEF SUMMARY OF THE INVENTION

A method, system, and computer program product for applying graphical hierarchical context in a search query. The method includes monitoring for receipt of a search string entry and detecting a search string entry. One or more search results associated with the detected search string entry are then determined. In addition, existing hierarchical placement information associated with at least one of the selected search result and at least one duplicate result of the selected search result is identified. Existing hierarchical placement information associated with the selected search result and at least one duplicate result of the selected search result includes at least one of: a lineal ancestor topic of the topic containing at least one of the selected search result and the at least one duplicate result, a collateral ancestor topic of the topic containing at least one of the selected search result and the at least one duplicate result, a sibling topic of the topic containing at least one of the selected search result and the at least one duplicate result, a lineal descendant topic of the topic containing at least one of the selected search result and the at least one duplicate result, and a collateral descendant topic of the topic containing at least one of the selected search result and the at least one duplicate result. Once the search results and its associated hierarchical placement information are retrieved, a topical hierarchy that includes the one or more search results and its associated hierarchical placement information is outputted.

### BRIEF DESCRIPTION OF THE SEVERAL VIEWS OF THE DRAWINGS

Aspects of the invention itself will best be understood by reference to the following detailed description of an illustrative embodiment when read in conjunction with the accompanying drawings, where:

FIG. 1 depicts an exemplary computer in which the present invention may be implemented;

FIG. 2 is a graphical representation of an exemplary search display interface showing an exemplary topical hierarchy graph according to an embodiment of the present invention;

FIG. 3A is a graphical representation of an exemplary topical hierarchy graph that is useful for understanding the invention;

FIG. 3B is a graphical representation of an exemplary abbreviated form of the topical hierarchy graph of FIG. 3A according to an embodiment of the present invention; and

FIG. 4 is a high-level flow-chart of exemplary method steps taken to implement a graphical hierarchical context in a search query.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java® (JAVA is a trademark or registered trademark of Sun Microsystems, Inc. in the United States and other countries), Smalltalk® (SMALLTALK is a trademark or registered trademark of Cincom Systems, Inc.), C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

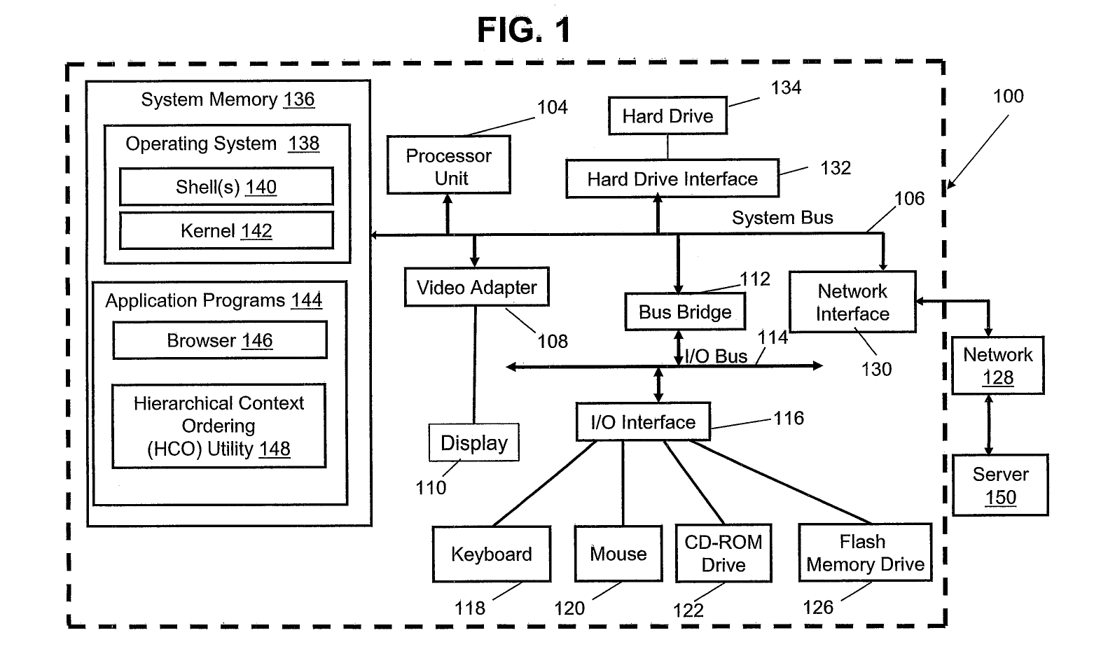

With reference now to the figures, and in particular to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN). Server 150 may be architecturally configured in the manner depicted for computer 100.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX® (UNIX is a registered trademark of The Open Group in the United States and other countries)) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

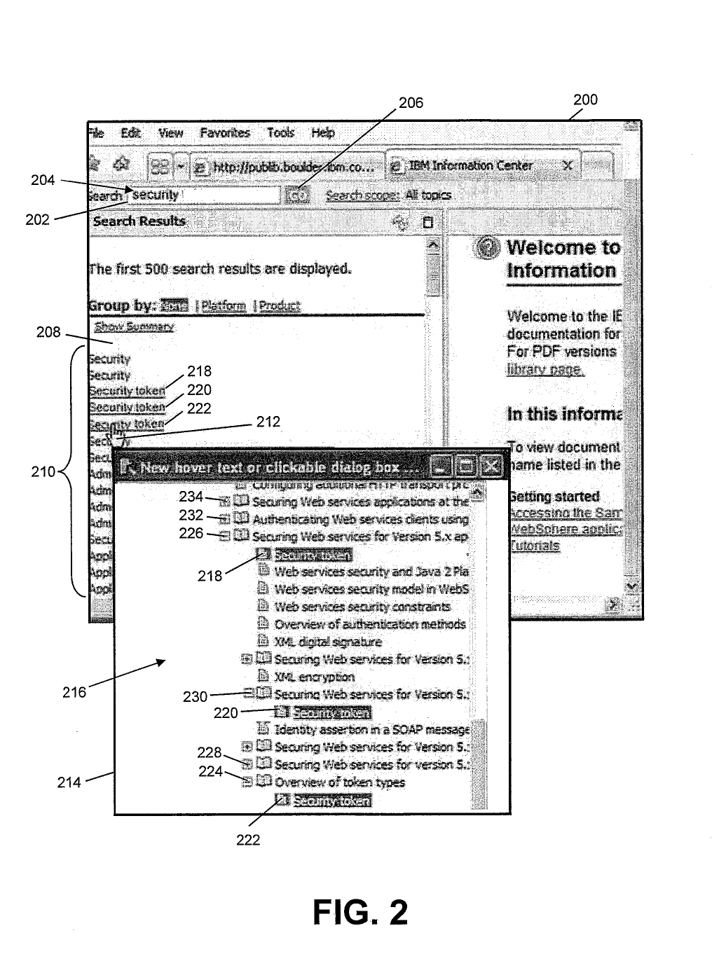

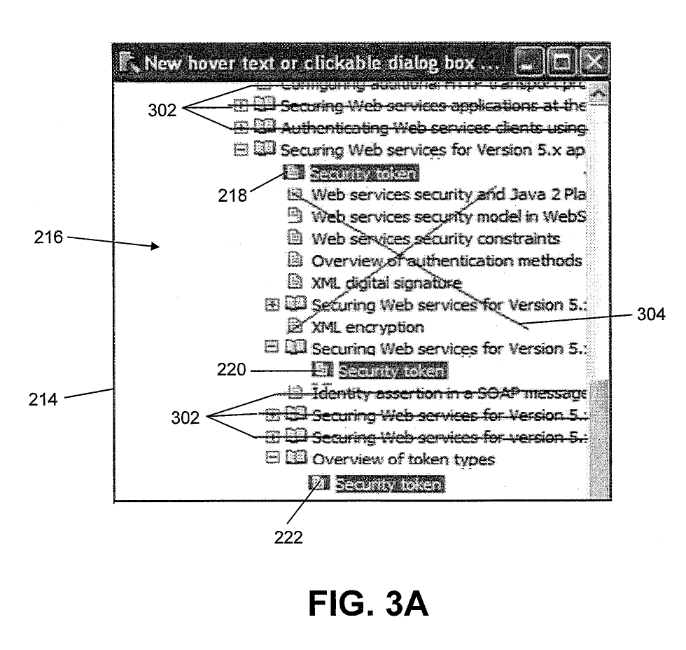

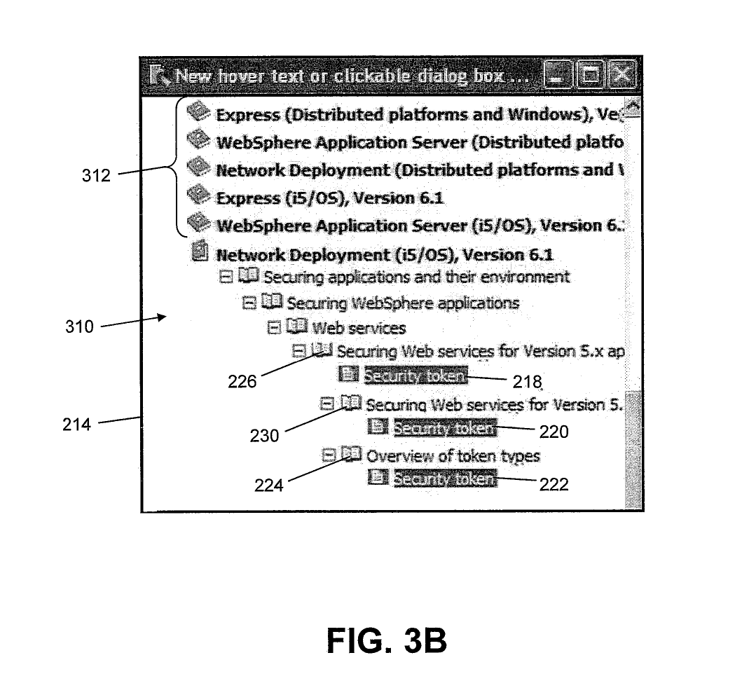

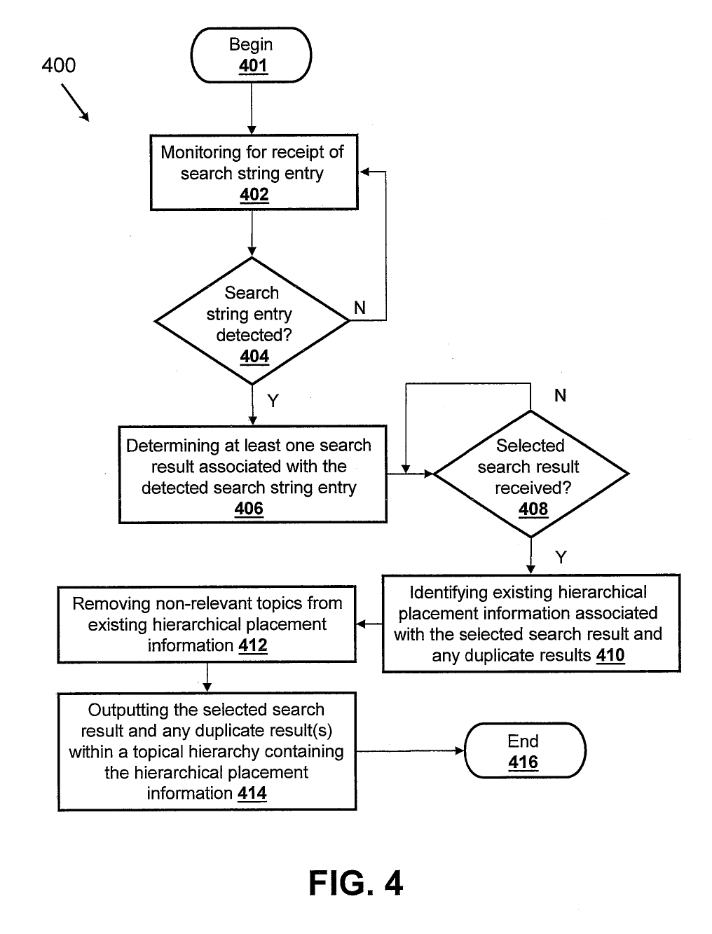

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include a Hierarchical Context Ordering (HCO) Utility 148. HCO utility 148 performs the functions illustrated below in FIG. 4, and may include all logic, helper functions, databases and other resources depicted below in FIGS. 2, 3A, and 3B.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

Referring now to FIG. 2, a graphical representation 200 of an exemplary search display interface is shown. Graphical representation 200 includes a search query box 202. In the example shown, a search string entry 204 (e.g., “security”) is entered in search query box 202. Upon selection of a search execution key 206, a search of a database (not shown) is executed to determine at least one search result that is associated with search string entry 204. A search results window 208 displays any and all search results. According to the example illustrated, the search using search string entry 204 yields numerous search results 210 containing the word “security”. Moreover, several search results 210 are duplicate results. For example, there are three identical results named “security token” of which two of these identical results are duplicate results of a selected search result). It is important to note that although graphical representation 200 is an online, Internet browser-based search query, the invention is not limited in this regard and other types of search interfaces, such as an offline-based search query, can be utilized. Moreover, the invention does not require that duplicate results be yielded for a particular search string entry; a single search result would suffice.

When a searcher hovers an icon 212 over one of the search results 210 (e.g., “security token”), a dialog box 214 containing an exemplary topical hierarchy 216 is graphically displayed. However, the invention is not limited in this regard, and other means of prompting a graphical display of exemplary topical hierarchy 216 can be utilized (e.g., right-clicking mouse (FIG. 1) over one of search results 210). Topical hierarchy 216 is organized in an outline view of topics based on existing hierarchical placement information. The hierarchical placement information is represented in any one of several markup languages, such as Extensible Markup Language (XML), HyperText Markup Language (HTML), Extensible HyperText Markup Language (XHTML), and LaTeX2e. In this regard, the topic(s) based on this existing hierarchical placement information includes one or more of the following topics that contain at least one of a selected search result (e.g., “security token”) and at least one duplicate result (e.g., “security token”) of the selected search result: a lineal ancestor topic, a collateral ancestor topic, a sibling topic, a lineal descendant topic, and a collateral descendant topic. As used herein:

a lineal ancestor is a parent, grandparent, great-grandparent, and on up a lineal trunk of a family tree;
a collateral ancestor is an ancestor not in the direct line of ascent, but of the same ancestral family.
a lineal descendant is a child, grandchild, great-grandchild, and on down a lineal trunk of a family tree; and
a collateral descendant is a descendant not in the direct line of descent, but of the same ancestral family.

Topical hierarchy 216 provides a hierarchical context within which the selected search result 222 (e.g., “Security token”) and its associated duplicate results 218 and 220 are located. For greater visualization and faster identification, selected search result 222 and its associated duplicate results 218 and 220 are highlighted within topical hierarchy 216. To further illustrate the hierarchical nature of topical hierarchy 216, it is important to identify the familial relationships within topical hierarchy 216. For example, selected search result 222 is contained within topic 224 titled “Overview of token types”. Topic 224 is a lineal descendant topic of topic 226 titled “Securing Web services for Version 5.x ap . . . . ” Stated another way, topic 226 (i.e., which contains duplicate result 218) is a lineal ancestor topic of topic 224 (i.e., which contains selected search result 222) and of topic 230 (i.e., which contains duplicate result 220). Moreover, topic 224 is a sibling topic of topics that are on the same hierarchical level, such as topics 228, 230. In addition, since duplicate result 218 is placed within the same level as topic 224, duplicate result 218 can also be viewed as a sibling topic to topic 224. With regard to other hierarchical relationships, topics 232 and 234 are collateral ancestor topics of topics 224 and 230.

Referring now to FIG. 3A, dialog box 214 of FIG. 2 is shown to illustrate the idea of removing one or more non-relevant topics from exemplary topical hierarchy 216 of FIG. 2. Removing non-relevant topics from a topical hierarchy assists a searcher by allowing him/her to focus on those topics which are more linearly related to the selected search result and its associated duplicate results. For exemplary purposes only, the non-relevant topics shown in FIG. 3A are represented by either strikethrough text markings 302 or cross-shaped markings 304. It is important to note that strikethrough text markings 302 and cross-shaped markings 304 are meant to illustrate which exemplary topics are to be removed before exemplary dialog box 214 is actually displayed (as is shown and described in FIG. 3B below). Furthermore, strikethrough text markings 302 and cross-shaped markings 304 are not intended to be displayed in actual implementation.

According to the embodiment shown in FIG. 3A, a non-relevant topic: (i) is not root topic (i.e., the topic does not have ancestors), (ii) is not a lineal ancestor topic of the topic containing at least one of the selected search result 222 and the at least one duplicate result(s) 218 and 220, (iii) does not contain at least one of the selected search result 222 and the at least one duplicate result(s) 218 and 220, and is not one of the selected search result 222 and the at least one duplicate result(s) 218 and 220. In addition to the aforementioned limitations (i)-(iii), the non-relevant topic can be a topic of the group comprising: a collateral ancestor topic of the topic containing at least one of the selected search result 222 and the at least one duplicate result(s) 218 and 220, a sibling topic of the topic containing at least one of the selected search result 222 and the at least one duplicate result(s) 218 and 220, and a descendant topic of the topic containing at least one of the selected search result 222 and the at least one duplicate result(s) 218 and 220. According to another embodiment, a non-relevant topic may include a root topic that is a collateral ancestor topic of the topic containing at least one of the selected search result 222 and the at least one duplicate result(s) 218 and 220.

Referring now to FIG. 3B, dialog box 214 (FIGS. 2 and 3A) is shown having an exemplary topical hierarchy 310, which is an abbreviated form of topical hierarchy 216 (FIGS. 2 and 3A). In this regard, topical hierarchy 310 displays: (a) selected search result 222, (b) duplicate results 218 and 220, (c) topic 224, which contains selected search result 222, (d) topics 226 and 230, which contain duplicate results 218 and 220, respectively, (e) lineal ancestor topics of topics 224, 226, and 230, and (f) root topics 312 that are not lineal ancestors of topics containing selected search result 222, duplicate result 218, and/or duplicate result 220. Moreover, all non-relevant topics (i.e., as described in conjunction with FIG. 3A) have been removed from topical hierarchy 310. As discussed earlier, another embodiment of the invention can remove root topics 312 from display. Such a decision whether to include/remove root topics 312 depends largely on how best to represent a topical hierarchy to a searcher.

As described in exemplary manner below, the present invention provides for a method for applying graphical hierarchical context in a search query. With reference now to FIG. 4, a high-level flow-chart of method 400 is shown. After initiator block 401, HCO utility 148 (FIG. 1) monitors for receipt of search string entry 204 (FIG. 2). A determination is made whether search string entry 204 is detected, as depicted in decision block 404. If the search string entry 204 is not detected, method 400 returns to block 402. However, if search string entry 204 is detected, method 400 continues to block 406, where at least one search result associated with the detected search string entry 204 is determined. From block 406, method 400 proceeds to decision block 408, in which a determination is made whether selected search result 222 (FIG. 2) is received by HCO utility 148.

Method 400 continues in decision block 408 until selected search result 222 is received by HCO utility 148. If selected search result 222 is received by HCO utility 148, HCO utility 148 identifies existing hierarchical placement information associated with selected search result 222 and any duplicate results 218 and 220 (FIG. 2), as depicted in block 410. Once the existing hierarchical placement information have been identified (block 410), method 400 continues to block 412, where non-relevant topics are removed from the existing hierarchical placement information that is used to create topical hierarchy 216 (FIGS. 2 and 3A). After the non-relevant topics are removed, selected search result 222 and duplicate results 218 and 220 are outputted (i.e., via display 110 of FIG. 1) within topical hierarchy 310 (FIG. 3B). Method 400 ends at terminator block 416. It should be understood that the step of removing non-relevant topics from the existing hierarchical placement information is one alternative that is taken to create the topical hierarchy. However, the invention is not limited in this regard. In such cases where the removal step is not executed, the topical hierarchy contains non-relevant topics, as shown in FIG. 2.

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for applying graphical hierarchical context in a search query, the method comprising:
monitoring receipt of a search string entry;
detecting a search string entry;
determining at least one search result that is associated with the detected search string entry;
responsive to receipt of a selected duplicate result, identifying existing hierarchical placement information associated with at least one of the selected search result and at least one duplicate result of the selected search result, wherein the existing hierarchical placement information includes at least one of: a lineal ancestor topic of the topic containing at least one of the selected search result and the at least one duplicate result, a collateral ancestor topic of the topic containing at least one of the selected search result and the at least one duplicate result, a sibling topic of the topic containing at least one of the selected search result and the at least one duplicate result, a lineal descendant topic of the topic containing at least one of the selected search result and the at least one duplicate result, and a collateral descendant topic of the topic containing at least one of the selected search result and the at least one duplicate result; and
outputting at least one of the selected search result and the at least one duplicate result within a topical hierarchy containing said hierarchical placement information.

2. The method of claim 1, the method further comprising:
prior to the outputting step, removing at least one non-relevant topic from the existing hierarchical placement information that is used to create the topical hierarchy, wherein said non-relevant topic: is not a root topic, is not a lineal ancestor topic of the topic containing at least one of the selected search result and the at least one duplicate result, does not contain at least one of the selected search result and the at least one duplicate result, and is not one of the selected search result and the at least one duplicate result.

3. The method of claim 2, wherein said non-relevant topic includes the collateral ancestor topic of the topic containing at least one of the selected search result and the at least one duplicate result, a sibling topic of the topic containing at least one of the selected search result and the at least one duplicate result, and a descendant topic of the topic containing at least one of the selected search result and the at least one duplicate result.

4. The method of claim 1, the method further comprising:
prior to the outputting step, removing at least one non-relevant topic from the topical hierarchy, wherein said non-relevant topic: is not a lineal ancestor topic of the topic containing at least one of the selected search result and the at least one duplicate result, does not contain at least one of the selected search result and the at least one duplicate result, and is not one of the selected search result and the at least one duplicate result.

5. The method of claim 1, wherein the topical hierarchy is graphically displayed in an outline view within a dialog box.

6. A computer program product for implementing graphical hierarchical context in a search query, the computer program product comprising:
a computer usable medium having computer usable program code embodied therewith, the computer usable program code comprising:
computer usable code configured for monitoring receipt of a search string entry;
computer usable program code configured for detecting a search string entry;
computer usable program code configured for determining at least one search result that is associated with the detected search string entry;
responsive to receipt of a selected search result, computer usable program code configured for identifying existing hierarchical placement information associated with at least one of the selected search result and at least one duplicate result of the selected search result, wherein the existing hierarchical placement information includes at least one of: a lineal ancestor topic of the topic containing at least one of the selected search result and the at least one duplicate result, a collateral ancestor topic of the topic containing at least one of the selected search result and the at least one duplicate result, a sibling topic of the topic containing at least one of the selected search result and the at least one duplicate result, a lineal descendant topic of the topic containing at least one of the selected search result and the at least one duplicate result, and a collateral descendant topic of the topic containing at least one of the selected search result and the at least one duplicate result; and
computer usable program code configured for outputting at least one of the selected search result and the at least one duplicate result within a topical hierarchy containing said hierarchical placement information.

7. The computer program product of claim 6, further comprising computer usable program code, configured for removing prior to said outputting step at least one non-relevant topic from the existing hierarchical placement information that is used to create the topical hierarchy, wherein said non-relevant topic: is not a root topic, is not a lineal ancestor topic of the topic containing at least one of the selected search result and the at least one duplicate result, does not contain at least one of the selected search result and the at least one duplicate result, and is not one of the selected search result and the at least one duplicate result.

8. The computer program product of claim 7, wherein said non-relevant topic includes the collateral ancestor topic of the topic containing at least one of the selected search result and the at least one duplicate result, a sibling topic of the topic containing at least one of the selected search result and the at least one duplicate result, and a descendant topic of the topic containing at least one of the selected search result and the at least one duplicate result.

9. The computer program product of claim 6, further comprising computer usable program code, configured for removing prior to said outputting step at least one non-relevant topic from the existing hierarchical placement information that is used to create the topical hierarchy, wherein said non-relevant topic: is not a lineal ancestor topic of the topic containing at least one of the selected search result and the at least one duplicate result, does not contain at least one of the selected search result and the at least one duplicate result, and is not one of the selected search result and the at least one duplicate result.

10. The computer program product of claim 6, wherein the topical hierarchy is graphically displayed in an outline view within a dialog box.

11. A computer system comprising:
a processor unit;
a memory coupled to the processor unit; and
a hierarchical context ordering (HCO) utility executing on the processor unit and having executable code for:
monitoring receipt of a search string entry;
detecting a search string entry;
determining at least one search result that is associated with the detected search string entry;
responsive to receipt of a selected duplicate result, identifying existing hierarchical placement information associated with at least one of the selected search result and at least one duplicate result of the selected search result, wherein the existing hierarchical placement information includes at least one of: a lineal ancestor topic of the topic containing at least one of the selected search result and the at least one duplicate result, a collateral ancestor topic of the topic containing at least one of the selected search result and the at least one duplicate result, a sibling topic of the topic containing at least one of the selected search result and the at least one duplicate result, a lineal descendant topic of the topic containing at least one of the selected search result and the at least one duplicate result, and a collateral descendant topic of the topic containing at least one of the selected search result and the at least one duplicate result; and
outputting at least one of the selected search result and the at least one duplicate result within a topical hierarchy containing said hierarchical placement information.

12. The computer system of claim 11, the HCO utility further having executable code for:
prior to the outputting step, removing at least one non-relevant topic from the existing hierarchical placement information that is used to create the topical hierarchy, wherein said non-relevant topic: is not a root topic, is not a lineal ancestor topic of the topic containing at least one of the selected search result and the at least one duplicate result, does not contain at least one of the selected search result and the at least one duplicate result, and is not one of the selected search result and the at least one duplicate result.

13. The computer system of claim 12, wherein said non-relevant topic includes the collateral ancestor topic of the topic containing at least one of the selected search result and the at least one duplicate result, a sibling topic of the topic containing at least one of the selected search result and the at least one duplicate result, and a descendant topic of the topic containing at least one of the selected search result and the at least one duplicate result.

14. The computer system of claim 11, the HCO utility further having executable code for:
prior to the outputting step, removing at least one non-relevant topic from the existing hierarchical placement information that is used to create the topical hierarchy, wherein said non-relevant topic: is not a lineal ancestor topic of the topic containing at least one of the selected search result and the at least one duplicate result, does not contain at least one of the selected search result and the at least one duplicate result, and is not one of the selected search result and the at least one duplicate result.

15. The computer system of claim 11, wherein the topical hierarchy is graphically displayed in an outline view within a dialog box.
